(19) United States
(12) Patent Application Publication
(10) Pub. No.: US 2015/0082459 A1
(43) Pub. Date: Mar. 19, 2015

(54) GEOLOCATION WITH CONSUMER CONTROLLED PERSONALIZATION LEVELS

(71) Applicant: SOLOMO IDENTITY, LLC., MADISON, WI (US)

(72) Inventors: Christopher W. Kelly, Madison, WI (US); Kyle McFarlane, Madison, WI (US); Elizabeth Eversoll, Verona, WI (US)

(73) Assignee: SOLOMO IDENTITY, LLC, MADISON, WI (US)

(21) Appl. No.: 14/030,042

(22) Filed: Sep. 18, 2013

(51) Int. Cl. H04L 29/06; H04W 12/08; G06Q 30/06

(52) U.S. Cl. CPC H04L 63/10; G06Q 30/0601; H04W 12/08
USPC 726/28

(57) ABSTRACT

A geolocation system provides for multiple levels of privacy authorization allowing flexible use by consumers who wish to obtain the benefits of localized product information promotion, balanced against a desire for precise control of their personal information. The geolocation system in one embodiment may convert scattered location data into continuous consumer trajectories to attain more accurate readings of consumer activity including dwell time, heat maps and customer conversions between different locations.

### STATEMENT REGARDING FEDERALLY SPONSORED RESEARCH OR DEVELOPMENT

--

### CROSS REFERENCE TO RELATED APPLICATION

--

### BACKGROUND OF THE INVENTION

The present invention relates to systems for identifying the location of mobile transmitters such as cell phones, and in particular, to a geolocation system that provides improved privacy to consumers using mobile transmitters in a geolocation area.

Geolocation systems allow approximate tracking of the location of mobile wireless devices, useful in an indoor environment or any location where GPS signals are unavailable or weak. Such systems may be used, for example, to locate critical personnel (such as medical personnel in a hospital or airline workers in an airport) or may be used to provide additional services to consumers in a retail environment including navigation or localized promotions such as coupons.

Geolocation can be implemented using the wireless access points and routers also used to establish a local area wireless network communicating with such mobile wireless devices, for example, using the IEEE 802.11 standard. By measuring the signal strength, signal phase and/or reception angle of wireless data communicated between a mobile wireless device and multiple access points, the location of the mobile wireless device may be established by multilateration or multiangulation, or other interpolated techniques (henceforth, collectively, signal-based location).

Geolocation can provide substantial benefits to consumers, for example, by providing them with special offers or services based on their location. Nevertheless, consumers may be concerned about how and when information about their locations is used. The relevance of geolocation services can be increased if the services are further tailored to personal information about the consumer. The linking of personal information to location information may also be a matter of concern to consumers.

### SUMMARY OF THE INVENTION

A first embodiment of the present invention provides a geolocation system that allows the consumer to control the use of their personal data and location data according to a consumer-controlled, tracking level authorization. In one embodiment, higher tracking level authorizations requiring additional, affirmative steps by the consumer beyond those required for lower level tracking.

Specifically, this embodiment provides a geolocation system having a set of wireless receivers positioned within a geolocation area for receiving transmissions from portable wireless devices of individuals within the geolocation area and at least one electronic computer communicating with the set of wireless receivers and executing a stored program. The stored program operates to identify locations of the portable wireless devices and to search for a stored tracking level authorization unique to the given wireless device. Use of the location information of the given wireless device is limited when no tracking level authorization is found.

It is thus a feature of at least one embodiment of the invention to allow the consumer to tailor geolocation services to his or her preferences.

The tracking level authorization may include a “checked-in” authorization authorizing only communication with the consumer's portable wireless device to provide content based on the identified location, or a “signed-in” authorization authorizing communication with the given portable wireless device to provide content based on the identified location and also based on authorized personal information about the owner.

It is thus a feature of at least one embodiment of the invention to provide multiple levels of geolocation authorization to allow the consumer to designate different levels of geolocation and personal engagement.

The electronic computer may set the tracking level authorization to “checked-in” permission when the owner of the given portable wireless device has (1) pre-authorized a “checked-in” authorization and (2) a predetermined application program running on the given portable wireless device.

It is thus a feature of at least one embodiment of the invention to provide a relatively simple authorization when low privacy interests are at issue.

Alternatively, the electronic computer may set the tracking level authorization to “signed-in” permission when the owner of the given portable wireless device has (1) pre-authorized a “signed-in” authorization, (2) a predetermined application program is running on the given portable wireless device and (3) the owner has validated acceptance of the “signed-in” authorization while in the geolocation area, for example, with a password.

It is thus a feature of at least one embodiment of the invention to require a more rigorous authorization when higher privacy interests are at stake.

The provided content may be information about products related to the consumer's location or discounts for sales of products related to that location.

It is thus a feature of at least one embodiment of the invention to provide specific benefits to a consumer that are possible when the consumer's location is known.

The tracking level authorization may be revocable by the owner of the given portable wireless device.

It is thus a feature of at least one embodiment of the invention to provide a reversible permission structure more accommodating to consumer privacy interests.

The identity of the given wireless device may be used only in one-way encrypted form when no tracking level authorization is found.

It is thus a feature of at least one embodiment of the invention to minimize any risk of personal identification of the consumer during anonymous geolocation.

In a second embodiment, the present invention provides a sophisticated geolocation system which synthesizes trajectories from a set of detected location points. These trajectories may be used to provide traffic maps showing consumer presence in given areas even when no location points were captured in those areas yet where travel through those areas may be inferred. The synthesized trajectories may be used to identify conversions in which customers move from one location to another, for example, motivated by a promotion at the first location, and may be used to provide a more sophisticated understanding of locations in which consumers linger, as well as other improved analytics.

Specifically, this embodiment of the invention may provide a geolocation system having a set of wireless receivers positioned within a geolocation area for receiving transmissions from portable wireless devices of individuals within the geolocation area and an electronic computer communicating with the set of wireless receivers and holding a stored program. The program may execute to identify locations of the portable wireless devices and to store a time-linked list of location points identified to specific portable wireless devices. The linked list of location points is assembled into at least one trajectory providing an inferred path with a direction through the geolocation area. An output report may then be generated based on analysis of the trajectory.

It is thus a feature of at least one embodiment of the invention to better analyze the retail consumer experience by using the more continuous and higher dimensioned data offered by trajectories compared to a scattering of points.

The geolocation system may store a map of physical obstacles within the geolocation area and the trajectory may be composed of multiple path segments fit to the location points to avoid the physical obstacles.

It is thus a feature of at least one embodiment of the invention to inform the calculation of the trajectory with the physical constraints of the retail environment.

The fitting of the location points to a trajectory may minimize the trajectory length within the constraints of the location points and avoidance of physical obstacles.

It is thus a feature of at least one embodiment of the invention to provide an automatic method of inferring a path of the consumer through a retail environment when only scattered location data is known.

The report generated by the system may be a view of a geolocation area overlaid with multiple path segments for the trajectories.

It is thus a feature of at least one embodiment of the invention to provide an intuitive output indicating consumer activity within the retail environment.

Each trajectory may be comprised of at least one segment having a defined spatial extent associated with a segment velocity providing an imputed velocity of the portable wireless device within the spatial extent of the segment.

It is thus a feature of at least one embodiment of the invention to provide additional time information in the trajectory data that may be useful in analyzing consumer location information.

In one example, the output report may provide a dwell level for a located area based on a time duration of trajectories within the located area, wherein the time duration of the trajectory within a located area is inferred from an overlap of the located area and the segments and from segment velocities of the trajectory.

It is thus a feature of at least one embodiment of the invention to provide sophisticated dwell analysis that more accurately reflects consumer behavior.

Alternatively or in addition, the output report may indicate a traffic level for a located area based on a density of trajectories within the located area different from a density of location points of the trajectory.

It is thus a feature of at least one embodiment of the invention to deduce actual consumer locations even when location points have not been captured at those locations.

The outputted report may indicate conversion events for each trajectory extending from a first predetermined location to a second predetermined location.

It is thus a feature of at least one embodiment of the invention to provide insight into how promotions in a geolocation area affect consumer purchase decisions.

The conversion may be indicated only if a time duration of the trajectory within the first predetermined location is above a first predetermined time and a time duration of the trajectory within the second predetermined location is within a second predetermined time.

It is thus a feature of at least one embodiment of the invention to limit the counting of conversions to situations where the consumer was significantly engaged at the beginning and end points of the conversion.

The program may further perform the step of identifying the given portable wireless device against a predetermined set of non-consumer portable wireless devices to exclude trajectories of non-consumer portable wireless devices.

It is thus a feature of at least one embodiment of the invention to limit analysis of geolocation to consumers without the need for personal information to identify the consumers.

These particular objects and advantages may apply to only some embodiments falling within the claims and thus do not define the scope of the invention.

### BRIEF DESCRIPTION OF THE FIGURES

FIG. 1 is a simplified perspective view of a geolocation system of the present invention in a retail location showing multiple geolocation nodes communicating with the computer system for determining a position of a portable wireless device;

FIG. 2 is a flowchart of a program executable on the computer system of FIG. 1 showing different uses of geolocation data according to different tracking level authorizations;

FIG. 3 is a mobile device database and a consumer database used by the program of FIG. 2 and providing additional services to consumers based on tracking level authorizations of anonymous, “checked-in”, and “signed-in”;

FIG. 4 is a detailed flowchart of the operation of the program of FIG. 2 during anonymous tracking level authorization;

FIG. 5 is a top plan view of a retail environment showing the conversion of time-linked location points into trajectories with segments for sophisticated analytics;

FIG. 6 is a top plan view of a geolocation area showing definitional areas for the determination of conversions;

FIG. 7 is a simplified representation of an output map that may be produced by the present invention; and

FIG. 8 is a representation of a series of display screens obtained from a remote Web server for managing tracking level authorizations by consumers.

### DETAILED DESCRIPTION OF THE PREFERRED EMBODIMENT

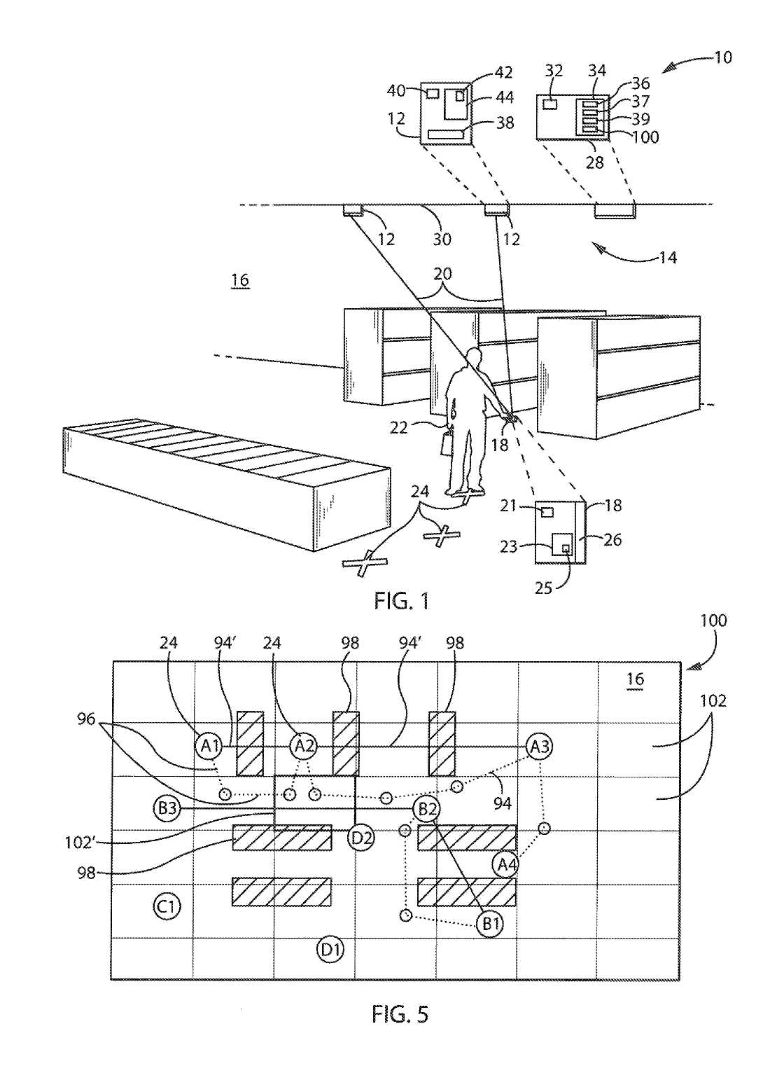

Referring now to FIG. 1, a geolocation system 10 of the present invention may provide multiple wireless access points or wireless routers 12, for example, as part of a wireless network 14 providing coverage over a geolocation area 16.

The wireless routers 12 may communicate with portable mobile wireless devices 18 such as cell phones or tablet computers through radio signals 20, for example, using the IEEE 801.11 (Wi-Fi) protocol. As is understood in the art, a portable wireless mobile wireless device 18 will generally include a processor 21 and an electronic memory 23 holding one or more stored programs 25, for example application programs as will be discussed below. The portable wireless mobile wireless device 18 will also include a variety of peripheral elements 26 including, for example, a Wi-Fi transceiver, a Bluetooth transceiver, a compass, a GPS receiver, an accelerometer, and a touchscreen or other form of graphical user interface.

The multiple wireless routers 12 may be interconnected to communicate with a geolocation computer 28, for example, using standard Ethernet cabling 30 and communication cards. The geolocation computer 28 may be located within the geolocation area 16 or remotely, for example, as connected by the Internet or the like. Generally, the geolocation computer 28 will include at least one processor 32 and electronic memory 34 holding a stored program 36, a device table 37, a promotion table 39, and retail area map 100 whose operation will be described below.

As will be understood to those of ordinary skill in the art, a wireless router 12 provides a transceiver 38 that may operate on multiple frequencies under the control of an internal computer 40 executing a program 42 stored in internal memory 44. This program handles a wireless communication protocol allowing data transfer to and from the mobile wireless devices 18. The wireless router 12 may also provide routing that allows data transmissions to be properly communicated to different mobile wireless devices 18 according to a contained routing table using methods well known in the art.

For the purpose of geolocation, each of the wireless routers 12 may also operate to monitor the signals from the Wi-Fi transceiver 38 to detect probe signals from mobile wireless devices 18. When a probe signal is detected, the signal strength of the probe signal is measured and that measurement linked to the MAC address of the mobile wireless device 18 and provided to the geolocation computer 28 which may spatially locate the wireless device 18. It will be appreciated that the signal strength value may be substituted for any other value useful for such spatial location including, for example, signal phase and/or reception angle. One lightweight wireless device for this purpose is described in co-pending U.S. application Ser. No. 13/959,908 filed: Aug. 6, 201 and hereby incorporated by reference. Probe signals are only transmitted when the Wi-Fi system is activated on the mobile wireless device 18 so absolute anonymity is provided when Wi-Fi is disabled on the mobile wireless device 18.

Depending on the frequency of occurrence of the probe signals and other considerations, the geolocation computer 28 will identify at different discrete times, a set of location points 24 representing positions of a consumer 22 possessing the wireless device 18 in two or three dimensions as they move through the geolocation area 16. Each of the location points 24 is identified to a particular wireless device 18, for example, by recording the MAC address of the wireless device 18 and is also identified to a particular time of detection.

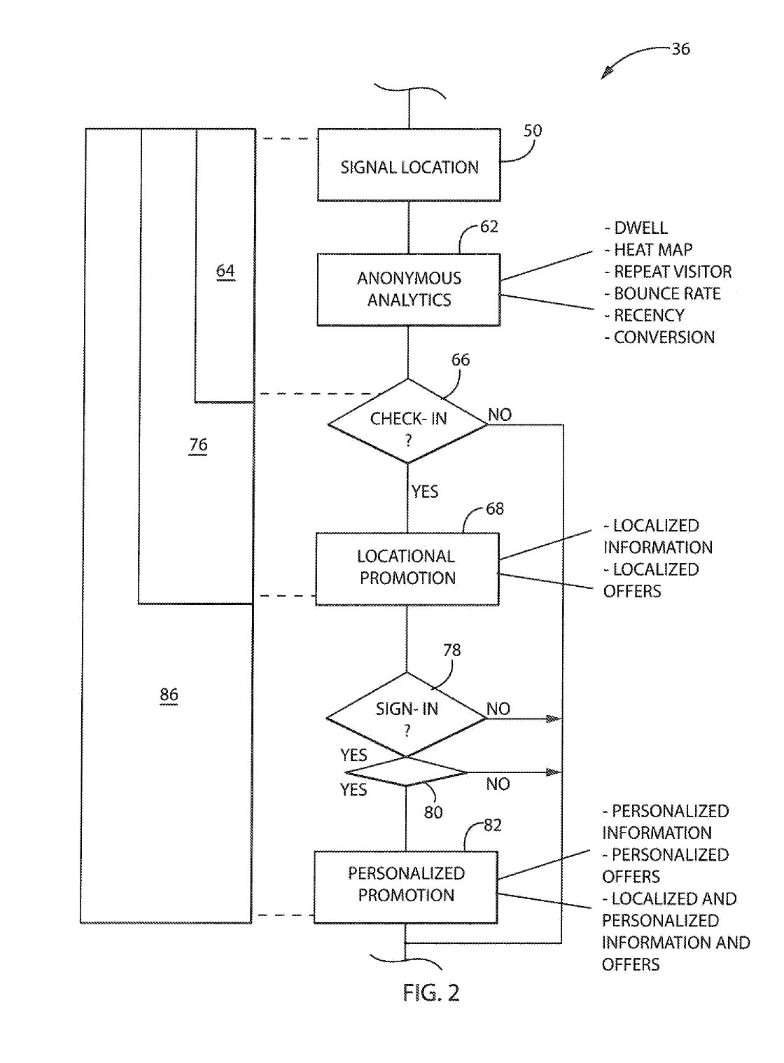

Referring now to FIGS. 1, 2 and 3, as the geolocation computer 28 receives the signal strength values from multiple wireless routers 12; it may determine the location points 24 by any signal-based location technique and store them in the device table 37 as an attribute in a record 52 as indicated by process block 50 of FIG. 2. Each record 52 may be associated with a particular wireless device 18 by processing the MAC address of the wireless device 18 to derive one-way encryption of the MAC address forming a first attribute 54 of the record. As will be understood to those of ordinary skill in the art, the one-way encryption establishes a unique mapping between an encrypted value and the MAC address that is not readily decrypted to establish the MAC address from the encrypted value.

While the link MAC address in itself does not provide personal information about the consumer 22, there may be personal information of the consumer 22 linked to MAC addresses in other contexts or databases outside of the geolocation system 10 and its use is minimized by the one-way hashing. As is understood in the art, a one-way hash is a one-way function that is easy to compute in a forward direction (converting the MAC address to the hash) but practically impossible to invert (computing the MAC address from the hash) even if the function is known.

After one-way hashing, mobile wireless device 18 is no longer identifiable although, multiple different signals from a given mobile wireless device 18 may be linked to a common but unidentified mobile wireless device 18 by common hashed MAC addresses.

A second attribute 56 in each record 52 provides a buffer holding the set of location points 24 (for example as Cartesian coordinate values) linked to their times of acquisition as described above.

A third attribute 57 provides for a tracking level authorization value 58 being one of “anonymous”, “checked-in”, and “signed-in”. This tracking level authorization value 58 defaults to a value of “anonymous” but can be set to the “checked-in” or “signed-in” values by receipt from the geolocation computer 28 of authorization by the consumer 22. Such authorization may be provided by way of a third computer managing the consumer's personal data, for example, as described in co-pending U.S. application Ser. No. 13/683,041 filed Nov. 21, 2012 and hereby incorporated by reference.

In some embodiments, the tracking level authorization values 58 of “anonymous”, “checked-in”, and “signed-in” may be augmented with a “no tracking” level in which a black list is stored at the wireless router 12 indicating a desire by the consumer 22 to be excluded from geolocation tracking. This blacklist is described in co-pending U.S. application Ser. No. 13/959,908 described above.

In one embodiment, the consumer 22 may indicate a desire for a “checked-in” tracking level authorization by downloading an application program into the mobile wireless device 18 for receiving geolocation-linked information or offers. The “signed-in” tracking level authorization value 58 may require a higher level of manifest consumer acceptance, for example a confirmation by the entry of a password on the application program loaded in the mobile wireless device 18 whenever the consumer 22 is in the geolocation area 16.

The tracking level authorization value 58 is forwarded to the geolocation computer 28, for example, from a Web server computer (not shown) communicating with the application program, for example, by one-way encrypting the consumer's MAC address so that it can be matched to the one-way encryption of the MAC address of the consumer 22 in the geolocation area 16.

When the consumer 22 has selected a “signed in” tracking level authorization value 58, table 37 may also be populated with consumer personalized information 61, for example, in attributes 60. Personalized information 61 may include personal data relevant to the retail experience such as gender, shirt size, pants size and the like. It will be appreciated that table 37 is a logical construct only and that this data may be held in multiple tables at different locations that may be relationally linked or arranged in other manners to provide the same function. Importantly, the signed in consumer 22 can limit use of personalized information 61, for example, by business/organization/brand (BOB), by what degree of tracking the BOB is allowed, by what personal information the BOB may use; where or at what times the BOB can contact the consumer 22 e.g. within a certain geo zone and/or within a certain time window, and how the BOB can contact the consumer e.g. text, email, SMS, etc. This ability to control the personalized information 61 is described in more detail in co-pending U.S. application Ser. No. 13/683,041 incorporated by reference above.

When the tracking level authorization value 58 is that of “anonymous” or higher (e.g. “checked-in” or “signed-in”) the program 36 may execute anonymous analytics, as indicated by process block 62 of FIG. 2. These anonymous analytics generally use location data (the location points 24) without identifying personal data of individual in any respect. This type of analytics may, for example, indicate the amount of time consumers 22 or groups of consumers 22 aggregate in certain locational areas within the geolocation area 16 (dwell), may indicate the density over a determined period of time of consumers 22 within a particular locational area within the geolocation area 16 (heat map), or may indicate that the consumer 22 has previously visited the locational area within the geolocation area 16 after a predetermined interval (for example a day) of absence (repeat map). This anonymous data may also be used to tally total visits by a consumer 22 within a period of time or average frequency of visit by consumer 22 or recency of previous visit of consumer 22. The one-way encrypted MAC address allows connection of these visits without personally identifying the consumer 22. In addition, the anonymous geolocation data may be used to determine whether a given consumer 22 remained in a located area for a time sufficient to engage with the merchandise by inspection or purchase (bounce rate). Generally, this anonymous geolocation data also may be used to establish ratios of those visitors who are in the different privacy categories (percent identified), to determine ratios of repeat visitors to first-time visitors (repeat visitor ratio) and to filter repeat visitors to determined how many different visitors have visited geolocation area 16 in a given period of time (unique visitors). Importantly, this information may be used to identify causal relationships between a consumer 22 visiting different locations within the geolocation area, for example, in seeing a promotion in one location and responding to that promotion in a second location (conversion) as will be discussed below.

The above-described process blocks 50 and 62 generally form an anonymous response program section 64 responsive to an anonymous tracking level authorization value 58. The data collected in anonymous response program section 64 is also collected at higher tracking level authorization values 58. Generally, therefore, higher tracking level authorization values 58 provide all of the analytics possible with the preceding lower tracking level authorization values 58.

At decision block 66, if the consumer 22 has authorized “checked-in” tracking level authorization value 58 (or greater) the program 36 proceeds to process block 68 to provide geolocation specific information and content to the consumer 22 through the consumer's mobile wireless device 18. For this purpose, the program 36 may search the promotion table 39 providing promotions linked to particular locations revealed by geolocation. Each record 72 of the promotion table 39 may have a first attribute 70 identifying a particular location within the geolocation area at process block 68. These locations may be predefined areas or procedurally defined regions expressed as, for example, ranges of Cartesian coordinate values. When a matching record 72 is found based on a search for the current position identified by current location point 24, a location-specific content 71 (e.g., information or a promotional offer) per attribute 74 may be read from the promotion table 39 and provided to the consumer 22, for example, in the form of a coupon or information about products in the area of the consumer 22. Note that while such information or coupon is linked to location of the consumer 22, it need not relate to a product currently near the consumer 22, but may, for example, relate to other products associated with the product that the consumer is viewing. For example, a coupon may relate to a sale on athletic socks elsewhere in the store when the user is reviewing running shoes.

Process blocks 66 and 68 form a “checked-in” response program section 76 responsive to a “checked-in” tracking level authorization value 58 and incorporate the features of the anonymous response program section 64. Generally, the consumer 22 indicates a desire to participate in the “checked-in” response program section by the act of downloading an application program for receiving the geolocation-specific promotions or information which provides terms for this service that are agreed to by the consumer 22.

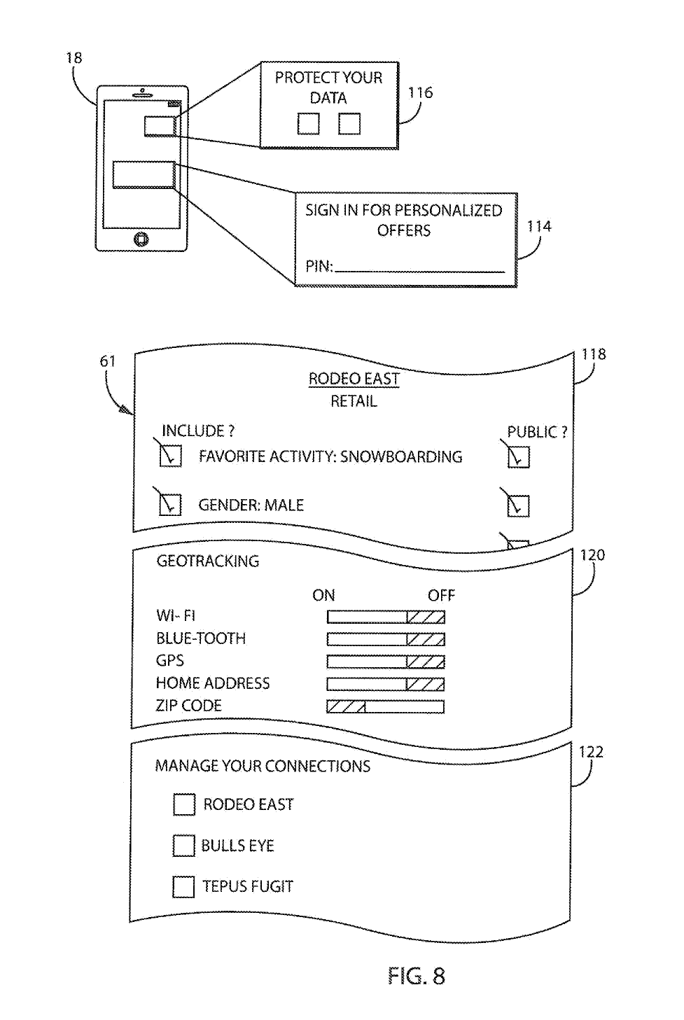

At decision block 78, if the consumer 22 has authorized a “signed-in” tracking level authorization value 58, the program 36 may proceed to decision block 80. At decision block 80, contemporaneous permission for the use of personal information is solicited from the consumer 22 through the mobile wireless device 18. This permission request may be triggered upon detecting the consumer 22 in the geolocation area 16 with the necessary application program running. If that authorization is forthcoming, typically in the form of a user-entered password, then the program proceeds to process block 82. Referring momentarily to FIG. 8, the consumer 22 may receive a sign in text box 114 pushed to their mobile wireless device 18 when they are detected within a relevant geolocation area 16, for example, determined by a correlation of encrypted Mac address as described elsewhere in the application. The consumer 22 may then enter a password to authorize “signed in” tracking.

In this case, promotion table 39 is reviewed not only for location-specific content 71 in attribute 74 but personalized content 85 that may be tied to either or both of current location and personal information of the consumer. The personalized content is provided in attributes 84.

The personalized content 85 may be delivered in lieu of location-specific content 71 in that it provides a more focused set of content to the consumer 22, for example, not providing content that is unlikely to be of interest to the consumer 22 even given the consumer's location. In this way, the consumer's attention is not distracted by irrelevant information or offers. For example, a promotion may be targeted to women currently looking at athletic shoes who have expressed a certain manufacturer preference. Alternatively this personalized content 85 may supplement location-specific content 71 to provide for additional targeted content making use of all of the information of location and personalized information 61.

This use of personalized information 61 may also help reduce locational uncertainty in the geolocation process, for example, to provide promotions for men's shoes only to one of two individuals (a man) looking at athletic shoes in a geolocation area where both men and women athletic shoes are in adjacent displays.

The personalized information 61 may also be used for advanced filtering with respect to any of the reports provided to businesses so that the various reports of dwell, heat map, repeat map, and conversions can be tied or filtered to particular categories of personalized information 61, for example, by gender or age.

Process blocks 78, 80, and 82 form a “signed-in” response program section 86 responsive to a “signed-in” tracking level authorization value 58 and incorporate the features of the “anonymous” response program section 64 and the “checked-in” response program section 76. Upon completion of process block 82, the program 36 may loop back to process block 50.

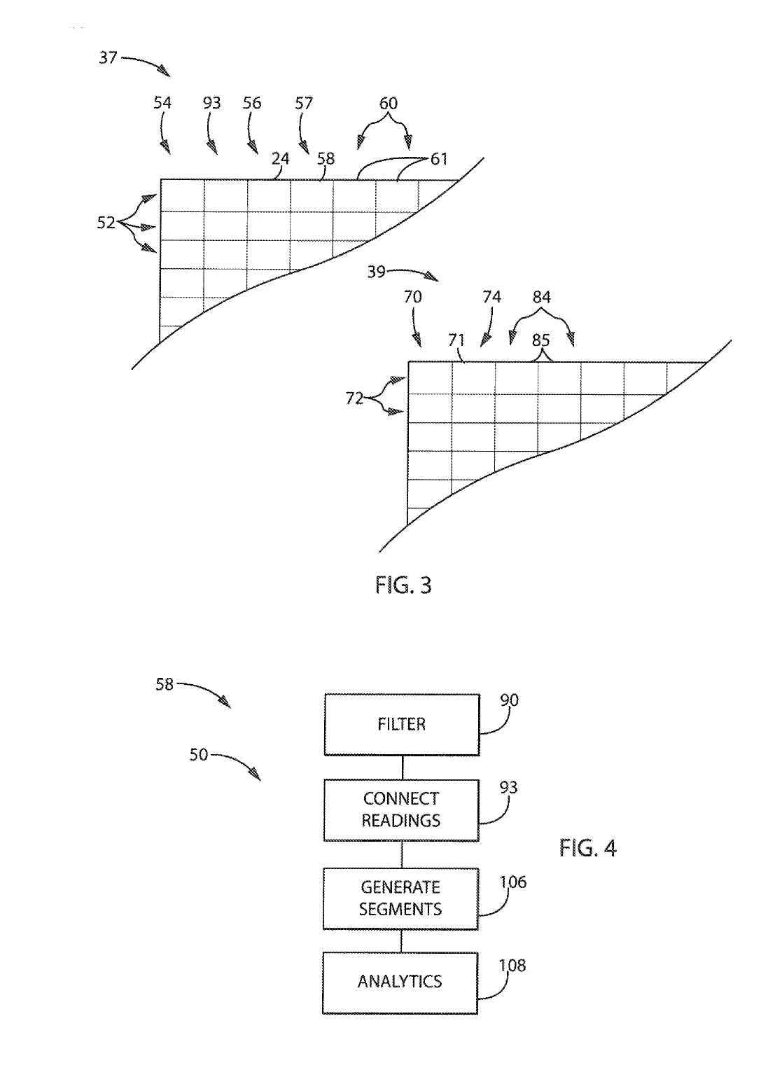

Referring now to FIGS. 2, 4 and 5, process block 50 of the “anonymous” response program section 64 may provide for improved geolocation processing by the conversion of a set of location points 24 into trajectories 94 relevant to consumer movement. At first sub process block 90, the receive location point 24 is filtered to eliminate individuals who are not consumers, for example store employees. Referring momentarily to FIG. 3, this may be done by establishing an attribute 93 for each record 52 in device table 37 identifying selected records 52 to mobile wireless devices 18 owned by employees. By pre-identifying only employees with respect to the MAC addresses of their mobile wireless devices 18, other consumers 22 may maintain full anonymity. Populating table 37 with the employee data attribute 93 may be done, for example, before the stores open each day by the assumption that individuals in the store are employees or non-consumers. Geolocation data related to employees as indicated by attribute 93 may be eliminated in the analysis and promotions of process block 62, 68 and 82.

At process block 97, each of the location points 24 (shown by circles in FIG. 5) may be linked according to the consumer 22 anonymously identified at attribute 54 (for example, individual “A”) and further linked to a time order of the location points 24 acquisition (indicated by suffix values 1, 2, 3, etc.). This linkage provides coarse trajectories 94′ providing a straight line point-to-point connecting of successive location points 24 in time. The coarse trajectories 94′ may be refined into fine trajectories 94 composed of a set of segments 96 per process block 106. The segments 96 follow the coarse trajectories 94′ only to the extent that the segments 96 need not span a physical barrier 98, for example a product display, that could not be crossed by consumer 22. The locations of these physical barriers 98 may be contained in a retail area map 100 providing a set of predefined located areas 102 which may be used for analytical purposes entered into the geolocation computer 28 and showing the locations of the physical barriers 92 with respect to the predefined located areas 102. The segments 96 may be determined automatically, for example, by collision detection algorithms of the type well known in the art and an optimization process minimizing total length of the segments 96 while observing the need to connect location points 24 and avoid physical barriers 98.

The generation of trajectories 94 allows a more sophisticated understanding of consumer location and movement. For example, a given located area 102′ may hold multiple segments 96, for example the segment between A1 and A2 and also the segment between A2 and A3 and the segment between B2 and B3, even though there are no location points 24 within that located area 102′. Thus the trajectories 94 provide greater insight into the location of consumers 22, for example, near an end cap display or retail display 98′ and would be obtained by simple analysis of location points 24.

Each of the segments 96 may be associated with a segment velocity representing the speed of a consumer walking at a constant speed along the path of the segments 96 between the end point location points 24, the constant speed being such that the consumer 22 may to be at each end point location points 24 at a time consistent with the times of acquisition of the location points 24. This segment velocity associated with each segment 96 allows more sophisticated analytics per process block 108, for example, with respect to determining consumer dwell time in a given area. As before, the use of trajectories 94 allow dwell time at a location, for example location 102′ to be determined despite the absence of location points 24. The dwell time, in this case for consumer A, could be determined by determining the length of segments 96 within located area 102′ and multiplying that length by the segment velocity for the overlap segment 96. Total dwell time for all individuals may be determined likewise.

In this case individuals C and D are identified as employees and accordingly no trajectories or other data are necessarily collected.

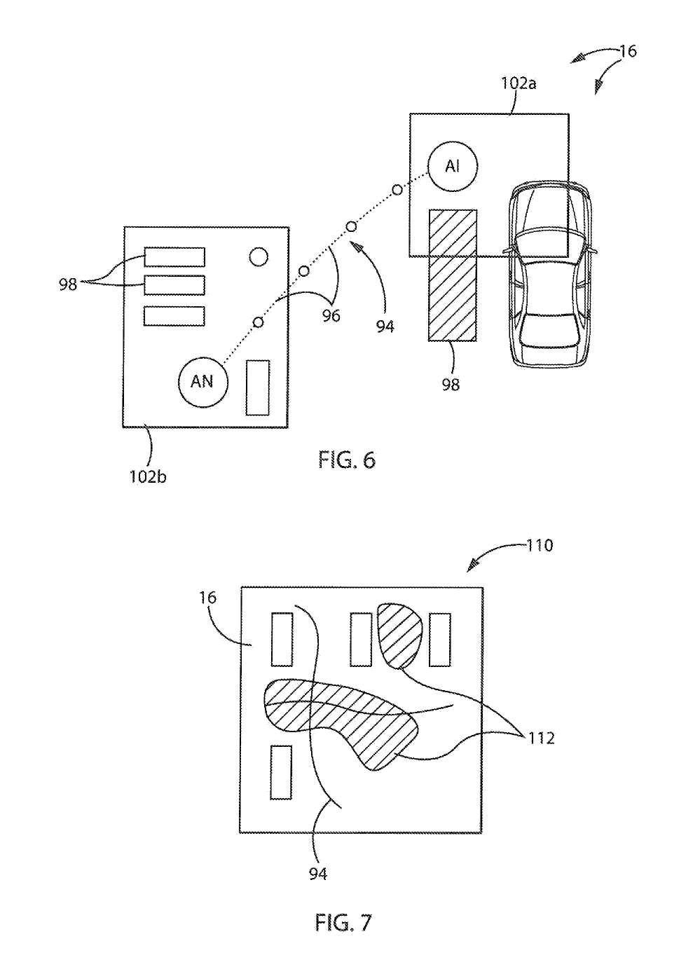

Referring now to FIG. 6, the present invention allows for the identification of two different located areas 102, for example located area 102a associated with a gas pump 98a and located area 102b associated with a convenience store. Knowledge of a trajectory 94 from located areas 102a to located areas 102b which include an imputed direction allows the identification of a “conversion” being a consumer 22 that moves from located area 102a directly or indirectly (as may be selected) to located area 102b. This information may be of interest to determine whether promotions associated with located area 102a (e.g., advertising placards or the like) encourage consumers to then shop in the convenience store of located area 102b. Thus conversions allow measurement of success or failure of such promotions. Conversions may be expressed as a total number of conversions per unit time or ratio of unique consumers converted versus those unconverted. Counting of a conversion may be limited by a requirement that the consumer 22 dwell a predetermined time in one or both of the located areas 102a and 102b such as may be established by the use of the dwell techniques described above. Thus, for example, a predetermined time may be required in located area 102a commensurate with the purchase of gasoline and in located area 102b commensurate with a purchase beyond simply payment for gasoline.

Referring now to FIG. 7, the output reports as discussed above may be expressed in terms of numerical figures or graphs over time or may be presented as map-type output reports 110 showing, for example, a plan view of the geolocation area 16 with trajectories 94 shown overlaid for a predetermined period of time or animated over that time, as well as additional metrics such as dwell time and heat maps represented as shaded areas 112 color-coded to particular quantitative values. This map may be two- or three-dimensional.

Referring now to FIG. 8, control by the consumer 22 of the tracking level authorization may be performed by accessing a Web server (for example implemented by the geolocation computer 28 or an external server) through a security pop-up 116 pushed to the consumer's mobile wireless device 18 when the consumer 22 is in the geolocation area 16. Access of the Web server may alternatively be provided through a standard URL address.

The Web server may provide a series of screens 118-122 allowing editing of personal information and control of tracking level authorization by the consumer 22 through standard web controls. For example, a first screen 118 may allow the consumer 22 to enter personalized information 61 related to a particular retailer associated with a current geolocation area 16. This information may be designated solely for use by that retailer or may be made public for use by other retailers. At screen 120, types of geolocation may be authorized, for example according to technology category (Wi-Fi, Bluetooth, and GPS) or granularity (home address and zip code) by appropriate web controls. For tracking by home address or ZIP code, the data may be either entered by the user or geolocation by another technology (for example Wi-Fi) may be abstracted to this lower level of precision. As described in co-pending U.S. patent application Ser. No. 13/683,041 hereby incorporated by reference, the Web server may further provide a screen 122 allowing management of the data of screens 118 and 120 for other retailers through a central management system. Here the relevant retailers are listed and hyperlinked to the screens 118 and 120 for those retailers.

The terms “checked-in” authorization” and “signed-in” authorization, are intended only for distinguishing two levels of permission and do not imply any other limitation with respect to how these authorization levels are implemented.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood depending on context to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. A geolocation system comprising:
a set of wireless receivers positioned within a geolocation area for receiving transmissions from portable wireless devices of individuals within the geolocation area; and
at least one electronic computer communicating with the set of wireless receivers and executing a stored program to:
(1) identify locations of the portable wireless devices based on the received transmissions from the wireless devices including a given portable wireless device;
(2) search for a stored tracking level authorization from an owner of the given portable wireless device unique to the given wireless device; and
(3) limit use of the location information of the given wireless device when no tracking level authorization is found.

2. The geolocation system of claim 1 wherein the tracking level authorization includes:
a “checked-in” authorization in which the owner of the given portable wireless device authorizes communication with the given portable wireless device to provide content based on the identified location but not based on personal information of the owner of the given wireless device.
{Automatic if application program is running}

3. The geolocation system of claim 2 wherein the electronic computer sets the tracking level authorization to “checked-in” permission when the owner of the given portable wireless device has pre-authorized a “checked-in” authorization and a predetermined application program is running on the given portable wireless device.

4. The geolocation system of claim 1 wherein the tracking level authorization includes:
a “signed-in” authorization in which the owner of the given portable wireless device authorizes communication with the given portable wireless device to provide content based on the identified location and authorized personal information of the owner of the given portable wireless device and wherein use of the location information is limited to be commensurate with the tracking level authorization.

5. The geolocation system of claim 4 wherein the electronic computer sets the tracking level authorization to “signed-in” permission when the owner of the given portable wireless device has pre-authorized a “signed-in” authorization and a predetermined application program is running on the given portable wireless device and wherein the owner of the given portable wireless device provides acceptance of the “signed-in” authorization through the predetermined application program while in the geolocation area.

6. The geolocation system of claim 4 wherein the authorized personal information is used to select individuals to be included in a report providing at least one of dwell level for a located area and traffic level for a located area based.

7. The geolocation system of claim 4 wherein the tracking level authorization includes:
a “checked-in” authorization in which the owner of the given portable wireless device authorizes communication with the given portable wireless device to provide content based on the identified location but not based on personal information of the owner of the given wireless device.

8. The geolocation system of claim 2 wherein the content based on identified location includes at least one of information about products linked to the location and discounts for sales of products linked to the location.

9. The geolocation system of claim 1 wherein the at least one electronic computer further executes a stored program to communicate with the owners of the portable wireless devices to receive input from the owners of the portable wireless devices setting the tracking level authorizations

10. A geolocation system comprising:
a set of wireless receivers positioned within a geolocation area for receiving transmissions from portable wireless devices of individuals within the geolocation area; and
at least one electronic computer communicating with the set of wireless receivers and executing a stored program to:
(1) identify locations of the portable wireless devices based on the received transmissions from the wireless devices and store a time-linked list of location points identified to specific portable wireless devices including a given portable wireless device;
(2) connect the linked list of location points into at least one trajectory providing an inferred path with a direction through the geolocation area; and
(3) output a report based on analysis of the trajectory.

11. The geolocation system of claim 10 wherein the at least one electronic computer stores a map of physical obstacles within the geolocation area and wherein the trajectory is composed of multiple path segments fit to the location points to avoid the physical obstacles.

12. The geolocation system of claim 11 wherein the fit minimizes the trajectory length within constraints of the location points and avoidance of physical obstacles.

13. The geolocation system of claim 11 wherein the report is a view of a geolocation area overlaid with multiple path segments for trajectories.

14. The geolocation system of claim 10 wherein each trajectory is comprised of at least one segment having a defined spatial extent associated with a segment velocity providing an imputed velocity of the portable wireless device within the spatial extent of the segment.

15. The geolocation system of claim 14 wherein the report provides a dwell level for a located area based on a time duration of trajectories within the located area, wherein the time duration of the trajectory within a located area is a time inferred from an overlap of the located area and segments of the trajectory and from segment velocities of the segments overlapped.

16. The geolocation system of claim 10 wherein the report indicates a traffic level for a located area based on a density of trajectories within the located area different from a density of location points of the trajectory.

17. The geolocation system of claim 10 wherein the report indicates conversion events for each trajectory extending from a first predetermined location to a second predetermined location.

18. The geolocation system of claim 17 wherein each trajectory is comprised of at least one segment having a defined spatial extent associated with a segment velocity providing an imputed velocity of the portable wireless device within the spatial extent of the segment and wherein a conversion is indicated only if a time duration of the trajectory within the first predetermined location is above a first predetermined time and a time duration of the trajectory within the second predetermined location is within a second predetermined time, wherein the time duration of the trajectory within a located area is a time inferred from an overlap of the located area and the segments of the trajectory and segment velocities of the segments overlapped.

19. The geolocation system of claim 10 wherein the report is a view of a geolocation area overlaid with indicia indicating data related to trajectories within the geolocation area.

20. The geolocation system of claim 10 further including the step of identifying the given portable wireless device against a predetermined set of non-consumer portable wireless devices to exclude trajectories of non-consumer portable wireless devices.
